(19) United States
(12) Patent Application Publication
(10) Pub. No.: US 2006/0114105 A1
(43) Pub. Date: Jun. 1, 2006

(54) Tire information detecting apparatus without distortion of amplitude modulation wave

(75) Inventor: Kota Iijima, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/273,842

(22) Filed: Nov. 14, 2005

(30) Foreign Application Priority Data
Nov. 16, 2004 (JP) 2004-331845

(51) Int. Cl. B60C 23/00

(52) U.S. Cl. 340/447

(57) ABSTRACT

An interrogator includes a first oscillator for outputting a first signal and a second oscillator for outputting a second signal, a power synthesis distributing circuit for synthesizing the first and second signals, an antenna which is coupled to a synthesis terminal of the power synthesis distributing circuit, a first mixer unit interposed between one distribution terminal of the power synthesis distributing circuit and the first oscillator, and a first switching unit which connects the other distribution terminal of the power synthesis distributing circuit to the one distributing terminal or the second oscillator. The other distribution terminal is connected to the second oscillator by the first switching unit during a transmitting period, and the other distribution terminal is connected to the first mixer unit during a receiving period.

### BACKGROUND OF THE INVENTION

1. Field of the Invention

The present invention relates to a tire information detecting apparatus for monitoring the pneumatic pressure of tires.

2. Description of the Related Art

A tire information detecting apparatus according to the related art will be described with reference to FIG. 4. A controller includes at least one generator G1 for generating radio frequency with respect to a carrier signal f1 at a microwave frequency band of about 2.4 GHz. The carrier signal f1 is modulated by at least one low frequency signal f2 which is generated by a generator G2 and preferably at a frequency band in the range of 1 to 30 MHz. As a result of the modulation, a desired supply frequency is generated. A signal of the generated frequency is amplified and transmitted by an antenna A1 disposed around a tire.

Preferably, the modulation means an amplitude modulation. According to the above-mentioned modulation method, a sideband is generated along the carrier frequency, at both right and left sides in a spectrum, for example, at portions of f1+f2 and f1−f2 by the amplitude modulation. When a plurality of frequencies f2 is used, by summing them, the sideband shown in the drawing generates a spectrum. The modulation is switched off by an electronic switch S1, and the electronic switch S1 is periodically controlled by a timer T1.

The tire includes at least one measured value transmitter MG1 (transponder), the measured value transmitter MG1 includes at least one antenna A2, a receiver having at least one diode, and a crystal resonator Q1 which is excited by a received modulation signal. The crystal resonator Q1 changes the resonant frequency on the basis of the tire pneumatic pressure, and again the crystal resonator Q1 is coupled to its own modulator diode or a mixer diode D2, or preferably, a varactor diode which has parametric gains. Further, the frequency varies on the basis of the measured values. The modulation is switched off at time t1 by the switch S1. Immediately after that, a receiver E1 becomes active at time t2 which is 1 μs after the time t1.

When the modulation of the supply frequency is switched off, the crystal resonator Q1 is further excited for about 1 ms. Since the carrier is still in presence, the supply frequency is modulated by the modulation diode D2. However, this happens when only a modulation frequency f2 already excites the crystal resonator Q1, that is, when the modulation frequency f2 substantially corresponds to a predetermined measured value. Since a supply signal is not modulated by the antenna A1 which can cause interference, the receiver recognizes a modulated signal of an antenna A3 by using an antenna A4, thus a measured value can be obtained through the modulation. When the modulation is not performed or it is performed a little, a predetermined measured value can be repeatedly sampled (see Japanese Patent No. 3494440).

In the transponder MG1, an amplitude modulation wave is detected by a diode D1 so that a modulation wave of the modulation frequency f2 is detected, and then the crystal resonator Q1 is excited by the detected modulation wave. However, it is necessary to increase the modulation degree of the amplitude modulation wave, in order to cause the crystal resonator Q1 to sufficiently be excited. On the other hand, when the modulation degree increases to cause the crystal resonator to be easily excited, the modulation wave is greatly distorted, thereby causing a spurious problem. Further, if the modulation degree decreases in order to escape the problem, the modulation level is lowered, whereby it is impossible to cause the crystal resonator (sensor) to be sufficiently excited.

### SUMMARY OF THE INVENTION

It is an advantage of the invention to solve the problems caused by the distortion of the amplitude modulation wave to be output from the controller (interrogator).

In order to solve the problems, according to an aspect of the invention, a tire information detecting apparatus, includes an interrogator which transmits an interrogation signal toward a tire of a vehicle during a transmitting period, and receives a reply signal including tire information such as a tire pneumatic pressure during a receiving period so as to process the signals; and a responder which has a sensor being excited by a predetermined frequency signal to detect the tire information and is disposed in the tire to return the reply signal to the interrogator during the receiving period in responding to the interrogation signal. The interrogator includes a first oscillator for outputting a first signal, a second oscillator for outputting a second signal which is separated from the first signal by a predetermined frequency, a power synthesis distributing circuit for synthesizing the first and second signals, an antenna which is coupled to a synthesis terminal of the power synthesis distributing circuit, a first mixer unit interposed between one distribution terminal of the power synthesis distributing circuit and the first oscillator, and a first switching unit which connects the other distribution terminal of the power synthesis distributing circuit to the one distributing terminal or the second oscillator, in order to constitute the interrogation signal. Further, the responder includes a second mixer unit which outputs a signal of frequency difference between the first and second signals by synthesizing the first and second signals. Furthermore, the other distribution terminal is connected to the second oscillator by the first switching unit during the transmitting period, and the other distribution terminal is connected to the first mixer unit during the receiving period.

### BRIEF DESCRIPTION OF THE DRAWINGS

FIG. 1 is a circuit diagram showing a construction of a tire information detecting apparatus according to the invention;

FIG. 2 is a circuit diagram showing an embodiment of a mixer unit to be used in the tire information detecting apparatus according to the invention;

FIG. 3 is a view showing a format of an interrogation signal of the tire information detecting apparatus according to the invention; and

FIG. 4 is a circuit diagram showing a construction of a tire information detecting apparatus according to the related art.

### DESCRIPTION OF THE PREFERRED EMBODIMENT

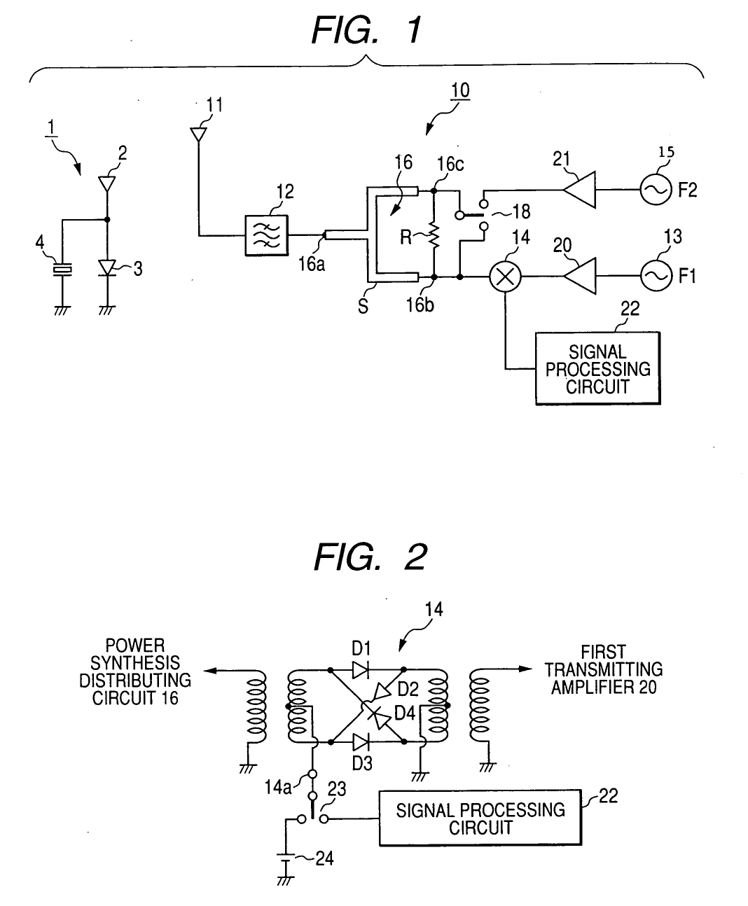

Hereinafter, a tire information detecting apparatus of the invention will be described with reference to FIGS. 1 to 3. In FIG. 1, a responder 1 is mounted in a tire (not shown) of a vehicle. An interrogator 10 is disposed in a vehicle main body (not shown).

The responder 1 includes an antenna 2, a second mixer unit 3 which is coupled to the antenna 2, and a sensor 4 which is coupled to the second mixer unit 3. The second mixer unit 3 is composed of non-linear elements such as diodes, etc. and functions as a frequency switching unit and a modulating unit. In addition, the sensor 4 is composed of a crystal resonator that is self-resonated when being excided by a signal having a self-resonant frequency or a frequency (for example, about 10 MHz) close thereto. The resonant frequency varies depending on the tire pneumatic pressure or the temperature. Several sensors may be provided according to tire information to be detected.

The interrogator 10 includes an antenna 11, a band pass filter 12 which is connected to the antenna 11, a power synthesis distributing circuit 16 (3 dB coupler) which is composed of a stripe line S and a resistor R and has a synthesis terminal 16a connected to the band pass filter 12, a first oscillator 13 for generating a first signal (F1), a first transmitting amplifier 20 for amplifying the first signal, a first mixer unit 14 which is connected between an output terminal of the first transmitting amplifier 20 and one distributing terminal 16b of the power synthesis distributing circuit 16, a second oscillator 15 for generating a second signal (F2), a second transmitting amplifier 21 for amplifying the second signal, and a first switching unit 18 for connecting the other distributing terminal 16c of the power synthesis distributing circuit 16 to the distributing terminal 16b or an output terminal of the second transmitting amplifier 21.

Further, a reply signal processing circuit 22 is coupled to a demodulation output terminal 14a of the first mixer unit 14.

Here, as shown in FIG. 2, the first mixer unit 14 is composed of a bidirectional double balance mixer having, for example, four diodes D1 to D4, and the demodulation output terminal 14a thereof is connected to the reply signal processing circuit 22 or a DC power source 24 via a second switching unit 23.

In the above construction, the first oscillator 13 generates the first signal (F1) of 2.4 GHz, and the second oscillator 15 generates the second signal (F2) of 2.4 GHz. A frequency difference (10 MHz) between those signals becomes an exciting frequency for exciting the sensor 4 of the responder 1.

Next, an operation of the tire information detecting apparatus of the invention will be described. Although typical tire information includes the tire pneumatic pressure or the tire temperature, for convenience of description, an operation for detecting only the tire pneumatic pressure will be described. If the tire temperature should be detected, a sensor required for detecting the tire temperature should be disposed in the responder 1.

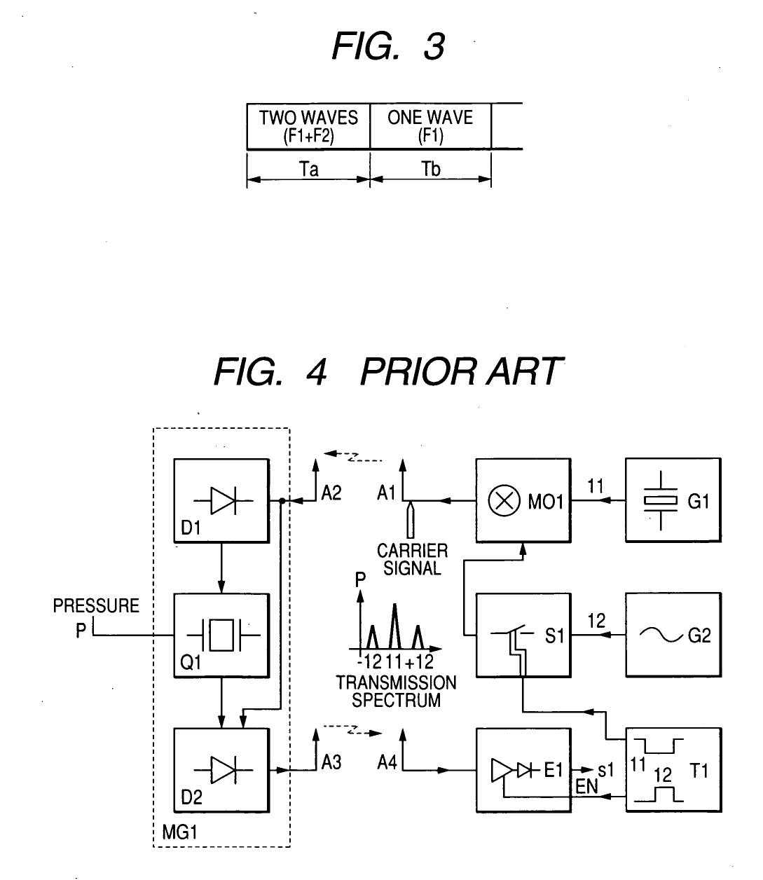

First of all, the interrogation signal to be transmitted to the responder 1 is divided into a signal during a transmitting period Ta and a signal during a receiving period Tb, as shown in FIG. 3. During the transmitting period Ta, the output terminal of the second transmitting amplifier 21 is connected to the other distributing terminal 16c of the power synthesis distributing circuit 16 by the first switching unit 18. Further, at this period, the DC power source 24 is applied to the demodulation output terminal 14a of the first mixer unit 14 by the second switching unit 23.

By applying the DC power source 24, the diodes D1 and D3 have conduction, and the first signal output from the first oscillator 13 is input to the power synthesis distributing circuit 16 via the first mixer unit 14. On the other hand, the second signal output from the second oscillator 15 is also input to the power synthesis distributing circuit 16. When the first signal and the second signal to be input to the power synthesis distributing circuit 16 are at the same level, the output terminal thereof outputs a synthesized signal (F1+F2) which is 6 dB higher (power ratio) than the same level. If the level of the first signal is lowered by a transmission loss caused by the first mixer unit, the synthesized signal comes to have a waveform like the amplitude modulation wave. However, the first signal and the second signal are transmitted from the antenna 11 to the responder 1 via the band pass filter 12.

In the responder 1, the synthesized signals (F1, F2) are mixed by the second mixer unit 3, and a signal of frequency difference (bit signal of 10 MHz) between those signals is generated, whereby the sensor 4 is excited by the signal of frequency difference. If so, the sensor 4 is resonated at the self-resonant frequency, and then the resonant state remains for a predetermined time. Since the resonant frequency varies depending on changes in the tire pneumatic pressure, the resonant frequency is used as information of the tire pneumatic pressure.

When the transmitting period Ta proceeds to the following receiving period Tb, the two distributing terminals 16b and 16c of the power synthesis distributing circuit 16 are short-cut by the first switching unit 18.

Then, only the first signal from the first oscillator 13 is transmitted to the responder 1 so as to be input to the second mixer unit 3. In the meantime, in the responder 1, since the sensor 4 continues to self-resonate, the signal of the resonant frequency is input to the second mixer unit 3 as well. Therefore, the first signal is AM-modulated by the signal of the self-resonant frequency in the second mixer unit 3, and the AM-modulated wave that is a reply signal is emitted from the antenna 2. The AM-modulated wave is received by the antenna 11 of the interrogator 10 so as to be input to the first mixer unit 14 via the power synthesis distributing circuit 16. At this time, although the reply signal is distributed into two reply signals at the power synthesis distributing circuit 16, the reply signals are synthesized as two distribution terminals 16b and 16c are short-cut, so that the reply signal is input to the first mixer unit 14.

Afterwards, the DC power source 24 is soon disconnected from the first mixer unit 14 by the second switching unit 23, and then the demodulation output terminal 14a is connected to the reply signal processing circuit 22. Since the first signal from the first oscillator 13 is also input to the first mixer unit 14, the first mixer unit 14 functions as a synchronous detector (the AM-modulated wave has the same frequency as that of the first signal). A detection signal (self-resonant frequency substantially close to 10 MHz) obtained by detection is output from the first mixer unit 14 so as to be input to the reply signal processing circuit 22. Tire pneumatic pressure information which has been processed by the reply signal processing circuit 22 is displayed on a displaying unit (not shown).

As described above, in the invention, only transmitting a signal of two waves instead of transmitting an amplitude modulation wave from the interrogator 10 can cause the sensor 4 to be excited. Therefore, the spurious problem caused by the distorted amplitude-modulation wave can be prevented. Although the modulation level is lowered, it is possible to satisfactorily excite the sensor 4. In addition, even though the first signal and the second signal are set at the same level, and are 6 dB lowered than a carrier level by a typical amplitude modulation wave, a bit signal (a signal of frequency difference) having the same level as a demodulation signal obtained by demodulating 100% amplitude modulation wave can be obtained. Further, it is needless to say that a bit signal of 10 MHz can be obtained by the second mixer unit 3 even though the first signal and the second signal are set at different levels. Furthermore, the transmitting period and the receiving period can be simply switched by the first switching unit 18.

According to the aspect of the invention, the interrogator includes a first oscillator for outputting a first signal, a second oscillator for outputting a second signal which is separated from the first signal by a predetermined frequency, a power synthesis distributing circuit for synthesizing the first and second signals, an antenna which is coupled to a synthesis terminal of the power synthesis distributing circuit, a first mixer unit interposed between one distribution terminal of the power synthesis distributing circuit and the first oscillator, and a first switching unit which connects the other distribution terminal of the power synthesis distributing circuit to the one distributing terminal or the second oscillator. Further, the responder includes a second mixer unit which outputs a signal of frequency difference between the first and second signals by synthesizing the first and second signals. Furthermore, the other distribution terminal is connected to the second oscillator by the first switching unit during the transmitting period, and the other distribution terminal is connected to the first mixer unit during the receiving period. Therefore, the first and second signals to be transmitted during the transmitting period cause the sensor of the responder to be excited. In addition, although a reply signal which is received during the receiving period is once distributed by the power synthesis distributing circuit, the reply signals are synthesized at the distribution terminal. Thus, the reply signal is input to the first mixer unit at a high level without loss.

1. A tire information detecting apparatus, comprising:
an interrogator which transmits an interrogation signal toward a tire of a vehicle during a transmitting period, and receives a reply signal including tire information during a receiving period so as to process the rely signals; and
a responder which has a sensor being excited by a predetermined frequency signal to detect the tire information and is disposed in the tire to return the reply signal to the interrogator during the receiving period in responding to the interrogation signal,
wherein the interrogator includes a first oscillator for outputting a first signal, a second oscillator for outputting a second signal which is separated from the first signal by a predetermined frequency, a power synthesis distributing circuit for synthesizing the first and second signals, an antenna which is coupled to a synthesis terminal of the power synthesis distributing circuit, a first mixer unit interposed between one distribution terminal of the power synthesis distributing circuit and the first oscillator, and a first switching unit which connects another distribution terminal of the power synthesis distributing circuit to the one distributing terminal or the second oscillator, in order to constitute the interrogation signal,
the responder includes a second mixer unit which outputs a signal of frequency difference between the first and second signals by synthesizing the first and second signals, and
the other distribution terminal is connected to the second oscillator by the first switching unit during the transmitting period, and the other distribution terminal is connected to the first mixer unit during the receiving period.
